(19) United States
(12) Patent Application Publication
(10) Pub. No.: US 2002/0179767 A1
(43) Pub. Date: Dec. 5, 2002

(54) System to synchronize the withdrawing and feeding motions of a flexible ribbon

(76) Inventor: Gino Rapparini, Bologna (IT)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/110,776

(22) PCT Filed: Apr. 2, 2001
(86) PCT No.: PCT/IB01/00535

(30) Foreign Application Priority Data
Apr. 6, 2000 (IT) BO2000A00193

(51) Int. Cl. B23Q 15/00; B65H 20/00; B65H 51/20

(52) U.S. Cl. 242/417.1; 226/97.2; 226/118.1

(57) ABSTRACT

A system to synchronize the withdrawing and feeding motions of a flexible ribbon (1), including a synchronizing chamber (6) through which is running the flexible ribbon, that presents a curvilinear part with the concavity pointing upwards (10, 11) by means of the suction of a device (4) applied at the bottom of the synchronizing chamber (6). A proximity sensor (4) detects the position of the curvilinear part (10, 11) and controls the synchronizing of the withdrawal and feeding motions, continuous or intermittent, of the running flexible ribbon.

### FIELD OF THE ART

The present invention concerns the construction technology of the machines that manipulate rolls of flexible ribbons in different technical fields,

Specifically, this invention refers to a system for synchronizing the continuous or intermittent unwinding of a film roll with the withdrawing, continuous or intermittent, of the flexible ribbon.

### STATE OF THE ART

Several traditional devices are known as “dandy roll”, made by articulations of mechanical arms and transmission rolls that set a ascending and descending path that allows to compensate, by changing the length of the excursions of the rolls, the cinematic differences among the feeding motion and the withdrawal motion of the flexible ribbon. It is known that such traditional “dandy roll” devices, because of the typical dynamic strains of accelerating bodies, can not reach high operating standards. It is also known that traditional “dandy roll” devices suffer the traditional “bump” phenomenon that is the main cause of functioning troubles.

The problem to be solved is to avoid “bumps” to occur by minimizing the inertia of the moving bodies.

The solution hereby proposed features an exceptional synchronization system that works without “dandy roll” mechanisms. Such new system eliminates the “bumps” and optimizes the synchronizing of the unrolling feeding motion of the flexible ribbon with its following withdrawal.

### DESCRIPTION

The invention, that can be very relevant in several application fields, is now disclosed in details with reference of the figures of the schematic drawings, attached as a not limiting example.

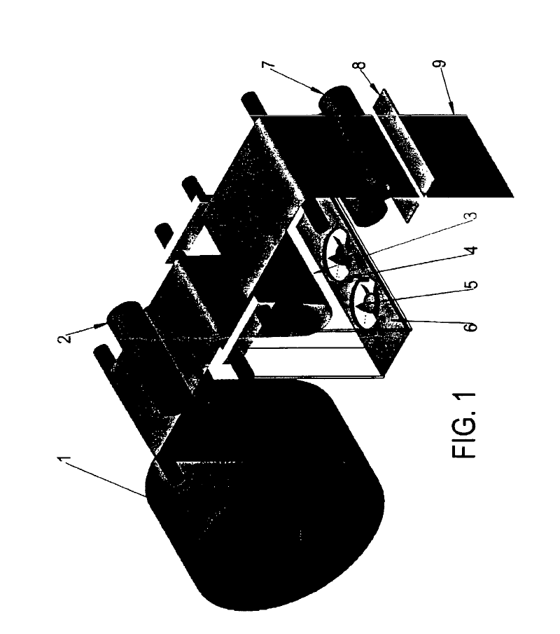

FIG. 1 represents a perspective view of a synchronizing system applied downstream of the roll of flexible ribbon that is to be unwound.

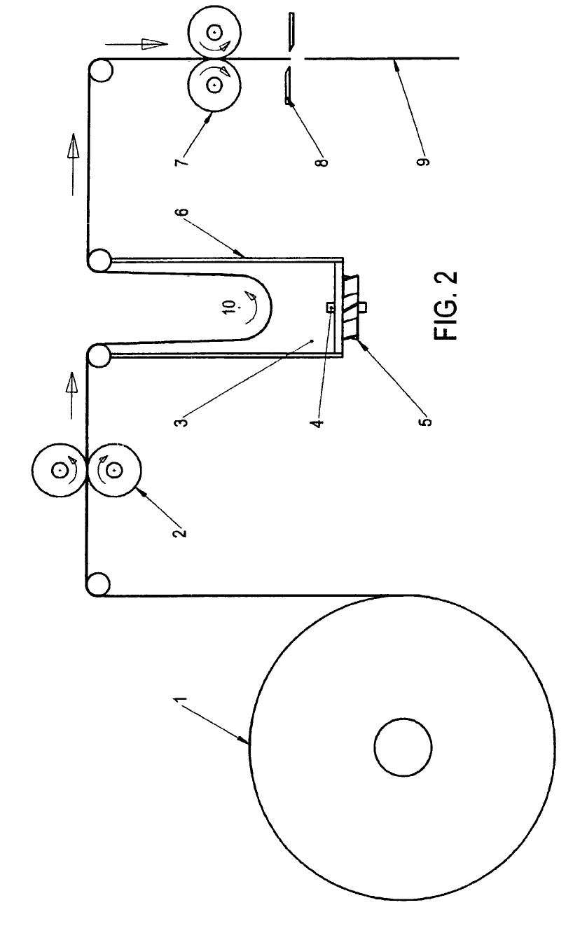

In the schematic FIG. 2 the curvilinear part (10) of the running ribbon is represented in the lower position inside of the synchronizing chamber (6).

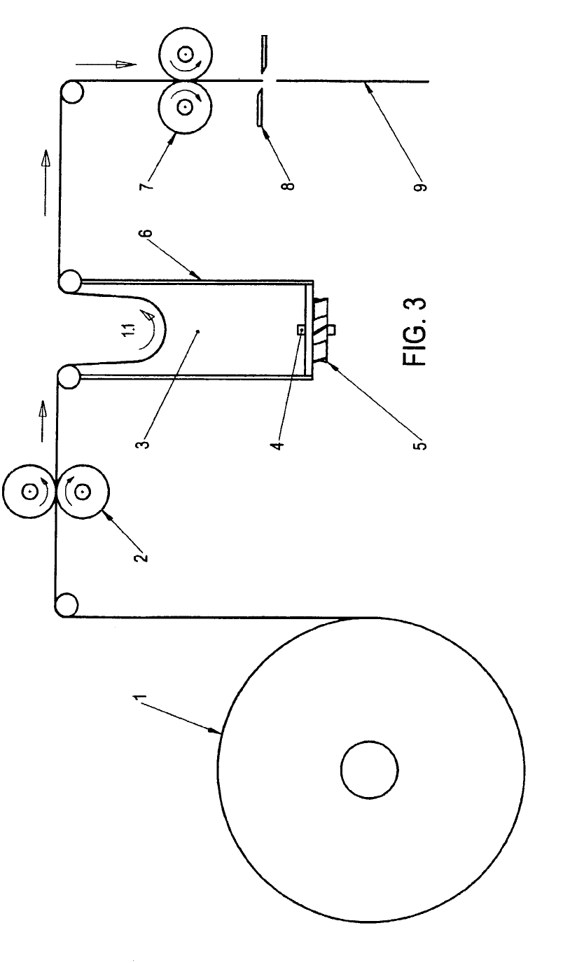

In the schematic FIG. 3 the curvilinear part (10) of the running ribbon is represented in the upper position inside of the synchronizing chamber (6).

One can notice right away that the “dandy rolls” are missing and that the running ribbon presents only one concave curvilinear part pointing upwards. In case of intermitting withdrawal and of continuous unrolling, the length of said curvilinear part varies at each cycle between two extreme positions and the excursion upwards is reduced by means of the continuous unrolling of the ribbon.

It can be also noticed that the atmospheric pressure uniformly distributed upon the curvilinear part (10, 11) keeps the tension of the withdrawn ribbon constantly at its minimum.

It is also evident that during the upwards excursion and the downwards comeback of the curvilinear part, some accelerations and decelerations occur, but the minimum inertial mass of the running ribbon does not causes relevant strains. It is therefore evident that the present system eliminates the “bump” characteristic of “dandy roll” mechanisms.

It can be also noticed that the upwards excursion of the curvilinear part happens during the intermitting withdrawal phase, while the comeback downwards excursion of the curvilinear part happens when the withdrawal device has stopped, whereas the unrolling motion continues. The cyclic oscillations of the curvilinear part of the ribbon are of course in phase with the intermitting withdrawal cycle. During the functioning of the system, the curvilinear part of the ribbon moves up and down as in a traditional “dandy roll”, but the masses involved are not considerable, thus allowing for very high production rhythms without “bump” phenomena.

It should also be observed that in case the ribbon's unrolling and withdrawal are both intermitting, the system intervenes to compensate the differences of phase between the two intermitting motions.

It is evident that the inventions allows several forms of practical realization, in which the structural proportioning, the dimensioning and the geometric configuration will be adjusted to the requirements of the technological process.

All those systems for synchronizing the unrolling and the withdrawal motions of a flexible ribbons that will be realized without the mechanical movements typical of the traditional “dandy rolls” mechanisms, and that present the innovative characteristics basically showed, described and hereinafter claimed will be therefore considered part of the basic principle of the present invention.

In the figures each single detail is marked as follows:

1 is the rolled flexible ribbon.

2 indicates the rolls that unwind the ribbon.

3 indicates the depression zone below the ribbon running inside of the synchronizing chamber.

4 indicates a proximity sensor that controls the position of the concavity (10, 11) of the flexible ribbon and synchronizes the rolls 2 and 7.

5 is a suction device that keeps depressed the lower zone (3) of the synchronizing chamber (6) below the curvilinear part of the ribbon.

6 is the synchronizing chamber.

7 indicates the withdrawal rolls of the flexible ribbon.

8 indicates the intermitting cutting device of the flexible ribbon.

9 indicates the cut part of the flexible ribbon.

10 indicates the lower position of the curvilinear part of the ribbon.

11 indicates the upper position of the curvilinear part of the ribbon.

It should be pointed out that the rolls 2 and 7 can be provided both with continuous and intermitting motion: the task of the synchronizing chamber is just to manage, control and synchronize the upstream feeding system with the withdrawal downstream system.

1) System to synchronize the withdrawal and feeding motions of a flexible ribbon (1) CHARACTERIZED BY THE FACT THAT it comprises a synchronizing chamber (6) through which runs a flexible ribbon (1), that presents a curvilinear part with the concavity pointing upwards (10, 11), by means of the suction of the device (4), applied at the bottom of said chamber (6).

2) System to synchronize the withdrawal and feeding motions of a flexible ribbon (1), as in claim 1, CHARACTERIZED BY THE FACT THAT the position of the curvilinear part (10, 11) of the ribbon (1) is detected by the proximity sensor (4) that manages the synchronization of the feeding and the withdrawal of the flexible ribbon.

3) System to synchronize the withdrawal and feeding motions of a flexible ribbon (1), as in the previous claims, CHARACTERIZED BY THE FACT THAT it performs the same functions of the traditional “dandy roll” mechanisms, but it does not present the typical dynamic “bump” phenomena, since it is not provided with inertial masses, and it therefore requires a minimum and easily adjustable effort to withdraw the ribbon. The system thus allows for great regularity of operation, more simplicity and convenience in the construction and very high reliability in the regulation of the synchronization of the unwinding and withdrawal motions of the notorious flexible ribbon.
